(19) United States
(12) Patent Application Publication
(10) Pub. No.: US 2015/0192604 A1
(43) Pub. Date: Jul. 9, 2015

(54) HOLDER FOR PROBE MICROSCOPE, PROBE MICROSCOPE AND SPECIMEN MEASUREMENT METHOD

(71) Applicants: Tsuyoshi Yamamoto, Tokyo (JP); Seiji Heike, Tokyo (JP); Akira Nambu, Tokyo (JP); Tomihiro Hashizume, Tokyo (JP); Hideaki Koizumi, Tokyo (JP)

(72) Inventors: Tsuyoshi Yamamoto, Tokyo (JP); Seiji Heike, Tokyo (JP); Akira Nambu, Tokyo (JP); Tomihiro Hashizume, Tokyo (JP); Hideaki Koizumi, Tokyo (JP)

(73) Assignee: HITACHI, LTD., Tokyo (JP)

(21) Appl. No.: 14/417,407

(22) PCT Filed: Jul. 27, 2012
(86) PCT No.: PCT/JP2012/069079

§ 371 Date: Jan. 26, 2015

(51) Int. Cl. G01Q 30/20; G01Q 60/24

(52) U.S. Cl. CPC G01Q 30/20; G01Q 60/24

(57) ABSTRACT

At the time of carrying out measurement of a biological tissue with a probe microscope, measurement is to be realized while maintain survival conditions for a cell.

As a holder for the probe microscope, a measurement holder including: a container in which a measurement object is housed; a first cover section which covers at least a part of the measurement object and has an aperture for inserting a measurement probe; and a second cover section which is connected to the first cover section, covers the container, and has an aperture for inserting the measurement probe, is used.

### TECHNICAL FIELD

The present invention relates to a holder for arranging a specimen in a microscope for measuring a biological tissue or the like with a high spatial resolution, a probe microscope using the holder, and a specimen measurement method using the microscope.

### BACKGROUND ART

In the case of measuring, evaluating and controlling a biological reaction such as adhesion of a cell to a biological base material in a culture solution, or subsequent extension and differentiation, hydration of biological molecules, biological tissues, biological base material or the like is important. In this case, the hydration structure shows a three-dimensional structure formed by an interaction between a specimen surface and water molecules and interactions including hydrogen bonding between water molecules, on a specimen-culture solution interface in a culture solution containing water as its principal component (NPL 1). So-called biocompatibility represented by adhesion between the inner wall of a blood vessel prosthesis and red blood cells or the like is considered to be closely related to this hydration structure. Moreover, ruggedness, potential distribution, composition distribution and sequence structure or the like of molecules and proteins or the like, on a specimen surface in a culture solution are particularly important characteristics for biological reactions of biological molecules, biological tissues, biological base material and the like in the culture solution.

As techniques for observing and measuring a specimen-culture solution interface of a biological molecule, biological tissue, biological base material or the like in a culture solution, optical microscopes and nonlinear optical microscopes based on the Raman spectroscopy, the second harmonic method, the sum frequency spectroscopy or the like are conventionally used. Particularly, the sum frequency spectroscopy can measure the sequence structure of water molecules that is related to the hydration structure on a specimen-culture solution interface. As a nonlinear optical microscope, for example, PTL 1 discloses a surface-selective nonlinear optical method using second harmonic light or sum frequency light based on water molecules, solvent molecules, or a marker substance near the interface with respect to an interaction between a probe and a target.

Meanwhile, a scanning probe microscope is based on atomic force microscopy (AFM). A scanning Kelvin probe microscope, which is an example of a scanning probe microscope, is a technique in which while an electrostatic field force acting between a cantilever with a conductive probe and a specimen is detected as a flexure of the cantilever, the probe is made to scan the surface of the specimen, thereby mapping electrostatic field force distribution. Since an atomic force or the like, other than the electrostatic field force, is applied to the probe, the electrostatic field force needs to be separated from other interactions. To do this, first, the cantilever is made to oscillate to adjust the probe-specimen distance in such a way that the oscillation amplitude reduced by the atomic force acting when the probe and the specimen contact each other is kept constant. Thus, the position in the direction of height of the specimen surface is decided, and in the state where the probe is moved away from the specimen surface by a predetermined distance from there, the electrostatic field force as a long-distance force is detected from phase change in the oscillation of the cantilever (for example, PTL 2).

### CITATION LIST

### Patent Literature

PTL 1: U.S. Pat. No. 7,139,843
PTL 2: JP-A-2011-27582

### Non Patent Literature

NPL 1: Second Harmonic and Sum Frequency Generation Imaging of Fibrous Astroglial Filaments in Ex Vivo Spinal Tissues, Yan Fu, Haifeng Wang, Riyi Shi, and Ji-Xin Cheng, Biophysical Journal, Apr. 30, 2007.

### SUMMARY OF INVENTION

### Technical Problem

A sum frequency microscope using a laser, which is a typical nonlinear optical microscope, is used to investigate the distribution and order of electron state, bond orientation and molecular orientation on a photocatalyst interface, surface adsorption system, semiconductor interface, and superconductor surface. However, since its spatial resolution is approximately 1 μm, the sum frequency microscope cannot observe micro structures.

Meanwhile, a scanning probe microscope can operate in a culture solution and can achieve a high resolution of approximately 10 nm by a relatively simple operation. However, since the probe and the specimen surface must contact each other in order to detect the position of the specimen surface, there is a problem that a detected signal becomes unstable if the probe tip gets broken or the specimen surface adheres thereto during measurement.

Also, in the case where measurement is to be carried out while maintaining survival conditions for a cell as a measurement object, if the temperature of about 37 degrees, which is one of the survival conditions for the cell, is maintained, the water (liquid, for example, culture solution) surrounding the cell evaporates and consequently there is a possibility that the survival conditions cannot be maintained because of the drying of the cell itself. As a result, it is impossible to acquire physical information from the cell or cell surface while maintaining the survival conditions for the cell.

However, the above conventional examples do not consider this point and do not describe a holder for holding a measurement object.

### Solution to Problem

Thus, the invention is provided in the form of a measurement holder including: a container in which a measurement object such as a cell is housed; a first cover section which covers at least a part of the measurement object and has an aperture for inserting a measurement probe; and a second cover section which is connected to the first cover section, covers the container, and has an aperture for inserting the measurement probe.

Also, using this holder, a cell or the like is measured with a probe microscope.

### Advantageous Effect of Invention

According to the invention, since a good condition of a specimen can be maintained without evaporation of a culture solution or the like, the degree of orientation of water molecules on the interface between biological molecules, biological tissues, biological base material or the like and water can be measured in a culture solution with a high spatial resolution while maintaining survival conditions for a cell, and the aggregation position and function of a specific element in a cell or cell cluster can be specified.

### BRIEF DESCRIPTION OF DRAWINGS

FIG. 1 shows a holder structure (1) disclosed in the invention.

FIG. 2 is an example of a configuration view of a probe microscope.

FIG. 3 shows a holder structure (2) disclosed in the invention.

FIG. 4 shows a holder structure (3) disclosed in the invention.

FIG. 5 shows a holder structure (4) disclosed in the invention.

FIG. 6 is a view of change with time in heart rate of a cultured cardiac muscle cell.

FIG. 7 shows a holder structure (5) disclosed in the invention.

FIG. 8 shows a holder structure (6) disclosed in the invention.

FIG. 9 shows a holder structure (7) disclosed in the invention.

FIG. 10 shows a holder structure (8) disclosed in the invention.

FIG. 11 shows a holder structure (9) disclosed in the invention.

FIG. 12 shows a holder structure (10) disclosed in the invention.

### DESCRIPTION OF EMBODIMENTS

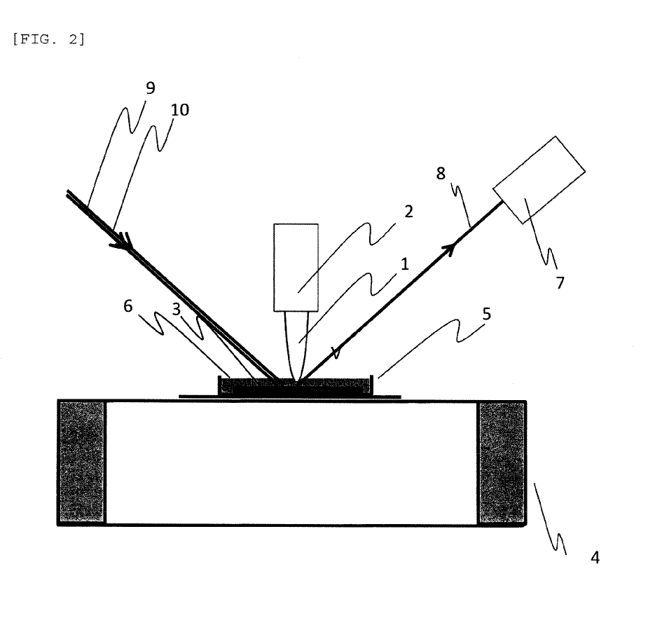

The invention discloses the structure of a specimen holder in the case of measuring a biological specimen and water specimen represented by a cell and water in a probe microscope. Prior to this disclosure, the structure of a scanning probe microscope (scanning Kelvin probe microscope) for measuring the distribution of an electrostatic field force acting between the probe and the specimen is disclosed in FIG. 2.

In this example (FIG. 2), a probe-enhanced scanning sum frequency microscope as a form of scanning probe microscope is disclosed. A probe 1 is installed on an oscillator 2 and its relative position to a specimen 3 is controlled by the oscillator 2. For the probe 1, a material such that the intensity of near-field light is amplified and concentrated near its tip when placed in incident light is selected. Meanwhile, if Raman scattering is used as in Raman spectroscopy, sum frequency spectroscopy or the like, a metal such as gold, silver, copper or aluminum, or a compound of these is used, in which surface enhanced Raman scattering can be used effectively. A probe formed by vapor-depositing a thin gold film with a thickness of 1 to 20 nm on a silicon probe is used as an effective probe candidate. Also, in this example, the oscillator 2 oscillates mainly in a perpendicular direction to the specimen 3. The distance between the probe 1 and the specimen 3 is controlled to 300 nm or below. Also, 200 kHz to 2 MHz is used as the specific frequency of the oscillator 2. While a crystal oscillator which expands and contracts in a longitudinal direction is used as the oscillator 2 in this example, a tuning fork-type crystal oscillator generally used in a scanning probe microscope such as atomic force microscopy, a piezoelectric element-based oscillator, an oscillator having a piezoelectric element arranged on a cantilever, or the like can be used.

By the oscillator 2, the probe 1 is made to oscillate in a perpendicular direction to the surface of the specimen 3 at a frequency close to the specific frequency of the oscillator 2 (within approximately ±1% of the specific frequency). An interaction (force) between the probe 1 and the specimen 3 generates a phase difference between the voltage applied to the oscillator 2 and the actual oscillation amplitude of the oscillator 2. With respect to the phase difference, in this example, based on the phase difference between the AC voltage applied to the oscillator 2 and the current flowing in the oscillator 2, the interaction (force) between the probe and the specimen is found and the distance between the probe and the specimen is found. Also, by scanning the relative position between the specimen 3 and the probe 1 in a perpendicular direction to the specimen and in a planar direction of the specimen by a scanning mechanism 4 while keeping this phase difference constant, it is possible to configure atomic force microscopy (AFM), which is a method of the scanning probe microscope, and to measure ruggedness on the specimen surface. The distance between the probe 1 and the specimen 3 is generally as close as 0 nm (contact) to 100 nm when in the closest position. However, the probe 1 can be sunk into the specimen 3. Also, by scanning the relative position between the specimen 3 and the probe 1 in a perpendicular direction to the specimen and in a planar direction of the specimen by the scanning mechanism while reducing the oscillation amplitude of the oscillator 2 by a predetermined amount, it is possible to achieve the distance of 0 nm between the probe 1 and the specimen 3 when in the closest position (tapping mode AFM).

A specimen holder 5 can hold and replace a culture solution 6. Also, water or a solvent can be used instead of the culture solution 6.

A pulse laser beam or a plurality of synchronously inputted pulse laser beams is inputted near an area of the specimen 3 to which the probe 1 comes close, and the intensity of output light 8 is measured by a detector with filter 7. In this example, a first pulse laser beam 9 which is a green pulse laser beam with a wavelength of 532 nm, and a second pulse laser beam 10 which is an infrared pulse laser beam with variable wavelengths of 2.3 to 10 microns, are inputted synchronously. The output light 8 is inputted to the detector with filer 7, and the intensity of the frequency as the sum of the frequency of the first pulse laser beam 9 and the frequency of the second pulse laser beam 10 is measured. By recording the intensity of the output light 8 of the sum frequency, which is dependent on the frequency of the second pulse laser beam 10, sum frequency spectroscopy is feasible. In this example, by comparing a peak with a wave number of 3200 kayser and a peak with a wave number of 3400 kayser, the rate of orientation of water molecules that are bonded asymmetrically with tetrahedrally coordinated water molecules on the interface between polycarbonate and the culture solution 14 can be specified.

While an example using pulse laser beams is described above, the pulse lasers and the detector are not essential in the case of measuring only the specimen surface.

### Example 1

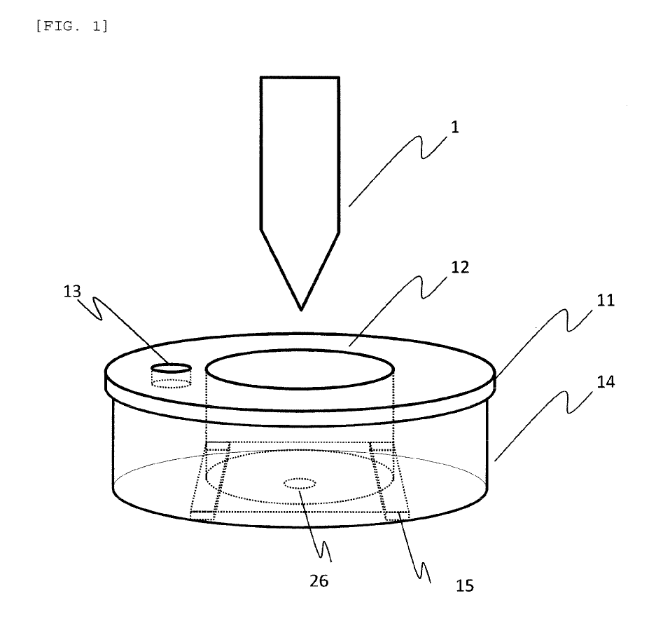

At the time of performing measurement, a specimen needs to be heated. At this time, evaporation of water, a culture solution or the like needs to be restrained and measurement needs to be realized while a cell is still alive. The structure of a specimen holder that is necessary to realize this is shown in FIG. 1. To realize a structure that facilitates insertion of the probe 1 into the holder, the structure is characterized in that a cylindrical hole is provided inside the holder. 11 is a cover and has a cylindrical hole 12 at its center. Also, 13 is a culture solution intake port and is provided to perform resupply to make up for the evaporated culture solution and water in order to maintain the temperature of the holder during the measurement (approximately 37° C. is considered desirable, but this temperature is not limiting). The culture solution intake port can also be used to discharge a liquid (culture solution) when the liquid has deteriorated.

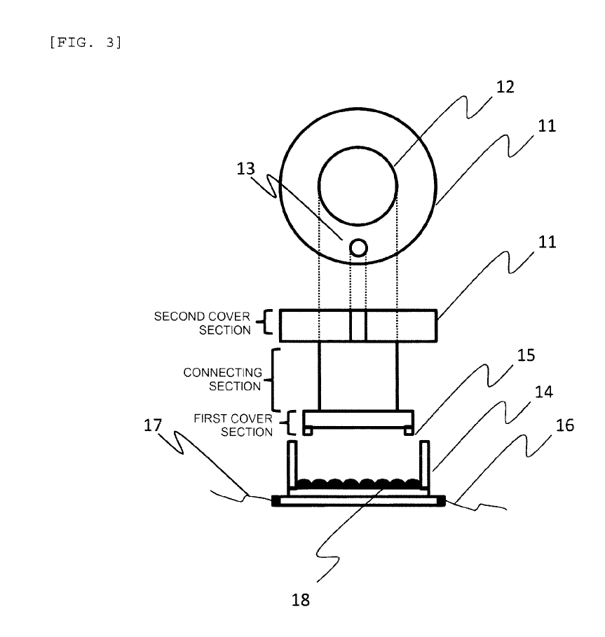

14 is a holder main body (container) and is fixed by the cylindrical hole 12 and the spacer 15. To supplement the structure shown in this FIG. 1, explanation is given using FIG. 3. This FIG. 3 is a side view of FIG. 1. The holder cover 11, the cylindrical hole 12 and the culture solution intake port 13 are provided concentrically. The spacer indicated by 15 is provided at a bottom part of the cylindrical hole. In this manner, a first cover section which covers apart of a specimen 18, a second cover section (holder cover) 11 which covers the holder main body 14, and a connecting section which connects the first cover section and the second cover section are provided. The first cover section is provided with a hole 26 through which the probe 1 passes. The second cover section (holder cover) 11, too, is provided with a hole 12 through which the probe 1 passes. The connecting section is a cavity.

These first cover section, connecting section and second cover section are connected to the holder main body 14.

Here, the spacer 15 is provided as a pad corresponding to the height of the specimen 18. However, if the specimen is flat or the like, the spacer is not necessarily essential since the hole 26 is provided. Also, while the shape of the spacer 15 is illustrated in FIGS. 1 and 3, an arbitrary shape can be employed since it is for padding.

Also, while the holder cover 11, the cylindrical hole 12 and the culture solution intake port 13 are described here as concentric, the hole 12 may have other shapes as long as the probe can pass through the hole. Of course, the shape of the culture solution intake port 13 need not be circular and may be in any shape. Also, though the holder cover is shown as having a columnar shape since the holder main body 14 is columnar, the holder main body is not limited to columnar and may be in an arbitrary shape as long as the holder main body can hold the specimen 18. Accordingly, the holder cover 11 may be connected in an arbitrary shape to the holder 14.

Also, to maintain the survival conditions for the specimen 18 for a long time, it is preferable to warm the specimen 18. If measurement ends in a short time, a heater for warming is not essential. In the case of warming, a heater 16 is connected to the holder main body 14, as shown in FIG. 3, and the temperature of the specimen holder is maintained. Also, for the purpose of measuring the temperature of the specimen holder, a temperature sensor 17 formed with a Peltier element or the like is connected. The specimen 18 represented by a cell or water can be arranged on this holder main body. Here, the configuration in which the holder main body 14 and the heater structure 16 are connected together has an advantageous effect in terms of costs, because the heater structure 16 can be used repeatedly even if the holder main body is discarded as a disposable item.

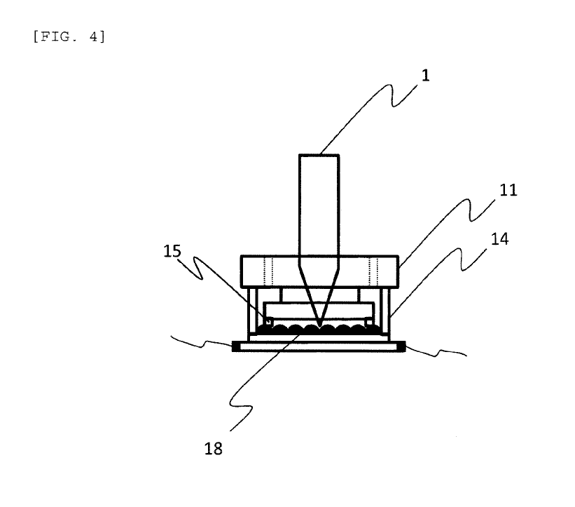

FIG. 4 is a view of actual mounting of the holder. The holder cover 11 and the holder main body 14 are in tight contact with each other and the spacer 15 is held in the state of light contact on the specimen 18. The probe 1 passing through the cylindrical hole 12 can approach the top of the specimen, in the form of penetrating the holder and the spacer.

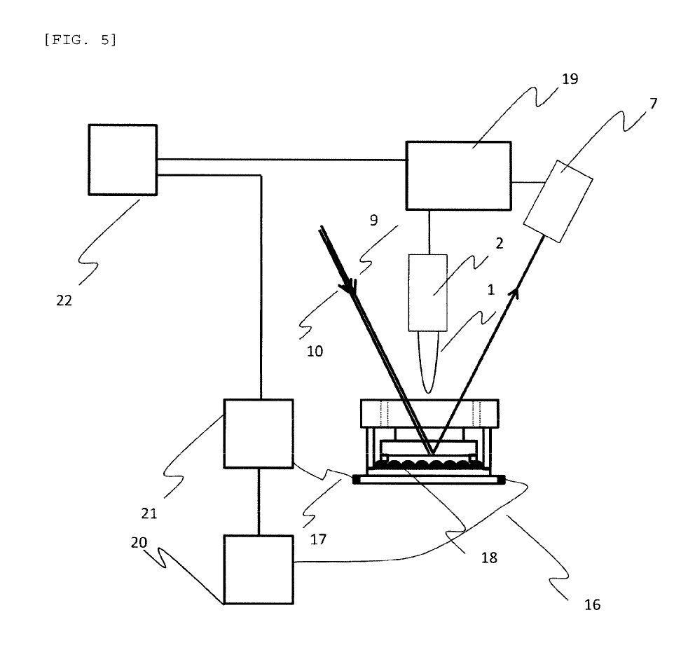

The actual method for using the holder shown in the drawings up to FIG. 4 is shown in FIG. 5. 19 is a control device for the probe microscope and is configured to carry out processing of the position of the probe 1 and the amount of light reaching the detector with filter 7. 20 is a control device for the heater. 21 is a detection device for the temperature sensor. The control device for the heater indicated by 20 and the detection device for the temperature sensor indicated by 21 are connected to each other and can set a predetermined desired temperature by controlling the temperature via a feedback system. The information of these set temperature and detected temperature, and the control device 9 for the probe microscope are connected to each other, and it is an electronic computer 22 that serves as a hub for transmission of such information.

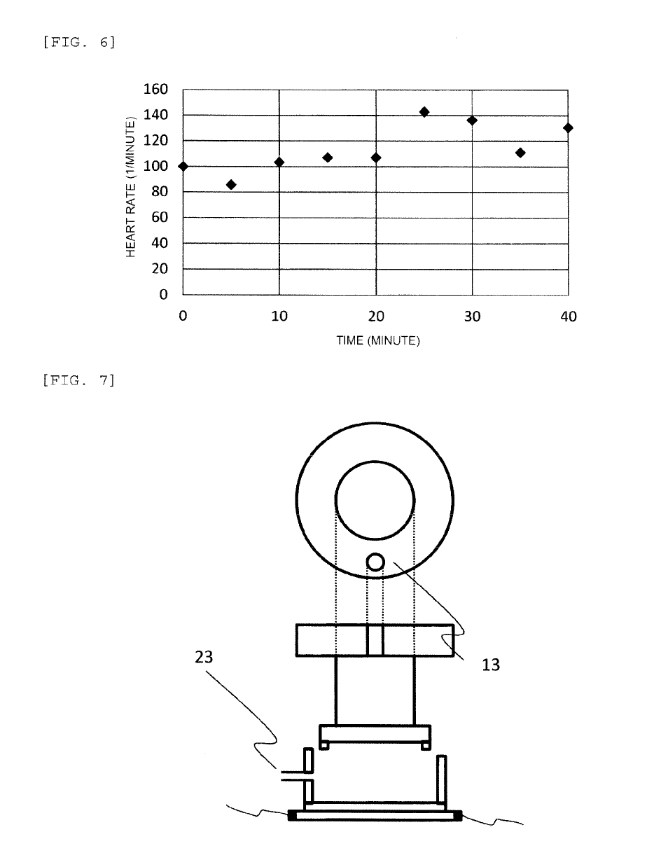

Using the holder disclosed in this example, image measurement of the heart rate of a cultured cardiac muscle of a rat (cardiac muscle cell culture kit by Primary Cell Co, Ltd.) is carried out. First, the heater 16 is warmed as an advance preparation. Meanwhile, the specimen kit 18 is arranged on the holder 14 and impregnated with a culture solution. Afterwards, the holder cover 11 is set via the spacer 15. Then, while the temperature of the holder is kept substantially constant using the heater 16 and the sensor 17, the surface shape and the state of the cell are observed for slightly less than an hour, using the oscillator 2, the probe 1 and pulse irradiation light. The culture solution is replenished through the hole 13 from time to time. The result of this is shown in FIG. 6. Although the preset temperature is 39° C., the temperature on the holder surface is 37° C. It is difficult to keep the heart rate perfectly constant due to the environment of the culture container. However, a heart rate of approximately 100 per minute is successfully maintained.

### Example 2

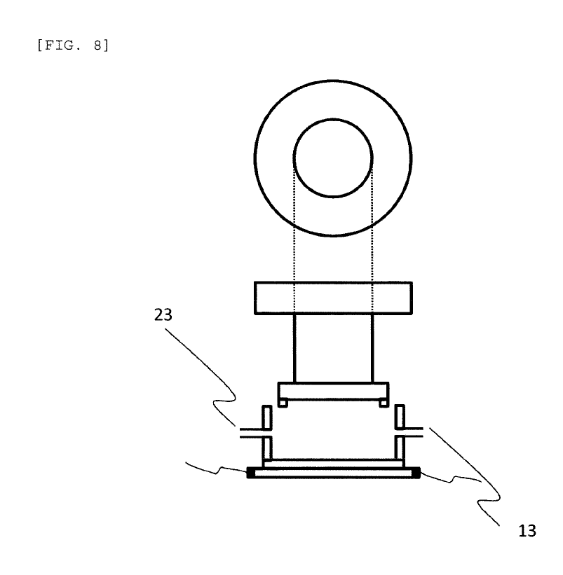

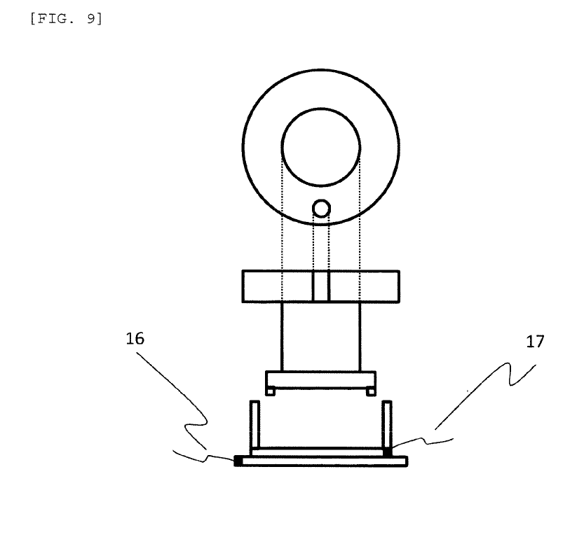

In this example, a modification of the holder is described. In the holder shown in FIG. 1, water and the culture solution are to be inputted from above the holder cover. However, in practice, there is a possibility that the culture solution may deteriorate, and a structure to avoid interference with the probe of the probe microscope needs to be provided. To solve these problems, a method for realizing injection and collection of water and the culture solution more easily is disclosed in FIGS. 7 and 8.

FIG. 7 discloses a holder characterized by having a culture solution discharge port 23 in addition to the culture solution intake port 13. This discharge port 23 is characterized by being provided on the lateral side of the holder. This is because it can easily realize discharge of the liquid that has deteriorated inside the holder, without obstructing the approach of the probe approaching from above, as described above.

Moreover, FIG. 8 discloses a structure in which the culture solution intake port 13, too, is provided on the lateral side of the holder. This enables realization of both injection and discharge of the culture solution in the form of avoiding the influence of interference with the probe. Meanwhile, in practice, it is possible to control the amount of injection and the amount of discharge by using a micro-syringe or the like, along with the injection and discharge. It is possible not only to carry out injection and discharge artificially but also to perform these controls using the electronic computer shown in FIG. 5.

Replenishing and collecting the culture solution as in this example has an effect that measurement can be carried out while the survival conditions are maintained, even if the measurement takes a longer time.

### Example 3

In this example, a modification of the method for carrying out temperature measurement with respect to the holder is described. In the holder structures described in Examples 1 and 2, the heater is installed in the bottom part of the specimen holder, and the heater and the temperature sensor are integrated. However, in this disclosed method, there is a possibility that the temperature may be different from the temperature with the actual specimen, due to the thermal conductivity of the holder. Thus, in this example, an invention relating the arrangement position of the sensor is disclosed.

In FIG. 9, a structure in which the temperature sensor 17 is inserted inside the holder main body is provided. This enables measurement of the temperature of the specimen 3 in the form of correctly reflecting the thermal conductivity of the holder formed with a plastic material or the like.

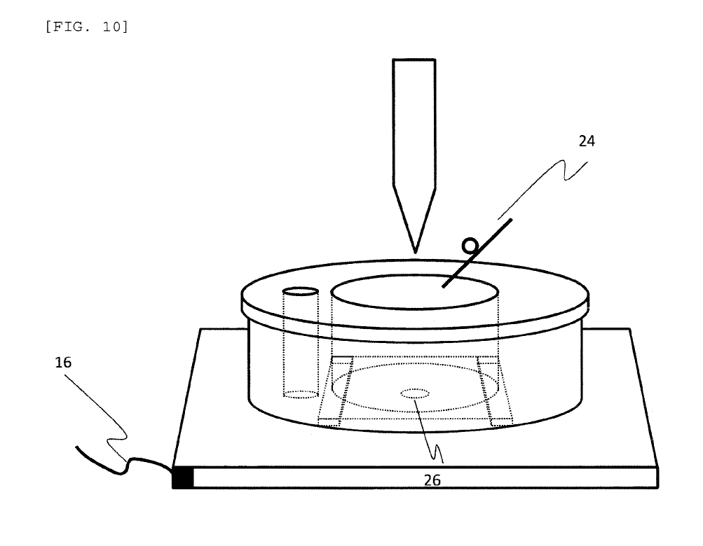

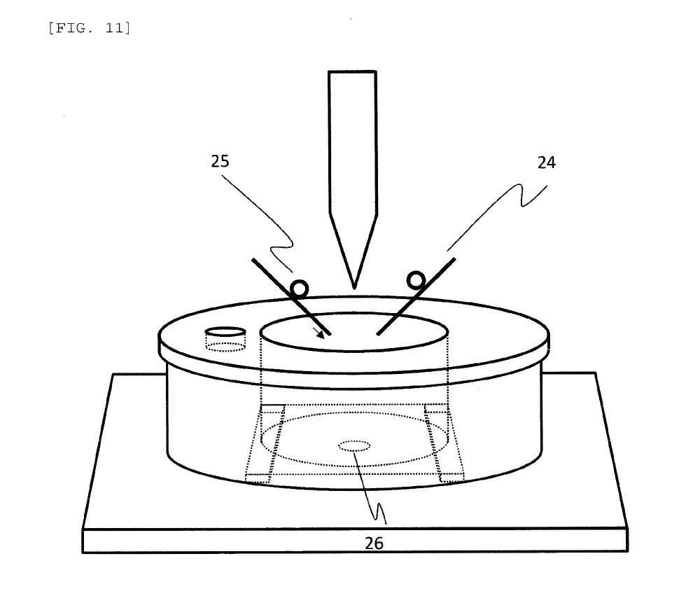

Meanwhile, FIG. 10 discloses a specimen holder characterized in that the temperature on the surface of the specimen 3 is measured using an optical fiber sensor 24. With this method, the installation of the temperature sensor 17 on the specimen holder 5 is no longer necessary and a simpler specimen holder can be realized.

Moreover, FIG. 11 discloses a structure of the specimen holder 5 characterized in that the specimen holder 5 is heated by irradiation with electromagnetic waves represented by a laser or light using an optical fiber 25 instead of the heater 16. It is desirable that the wavelength of the laser used for actual irradiation is in an infrared range or an adsorption wavelength band of the material of the specimen holder, considering that the specimen is a biological substance. By thus casting electromagnetic waves (light) from outside, the influence of electromagnetic noise at the time of measurement can be reduced better than in the case where the holder is directly heated by the heater.

### Example 4

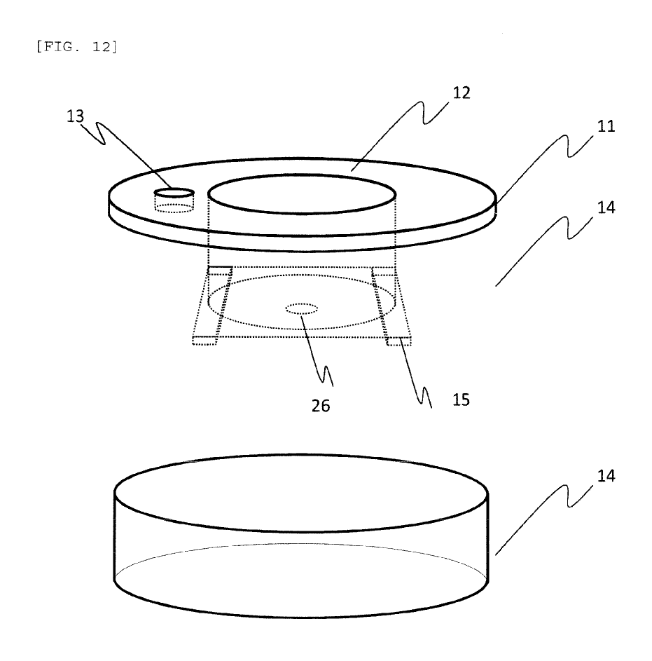

In this example, an attachment/removal structure of the holder is shown in FIG. 12. By thus enabling the holder cover 11 to be attached to and removed from the holder main body 14 and the spacer 15, it is possible to replace the cell within the holder main body (container) 14 and re-measure the cell. The top and bottom in FIG. 12 can each be cleaned and used repeatedly. Also, even during measurement, opening to the atmosphere from time to time enables the cell to breathe and further enables long-time measurement while maintaining survival conditions at high levels.

### REFERENCE SIGNS LIST

1 probe
2 oscillator
3 specimen
4 scanning mechanism
5 specimen holder
6 culture solution
7 detector with filter
8 output light
9 first pulse laser beam
10 second pulse laser beam
11 holder cover
12 cylindrical hole
13 culture solution intake port
14 holder main body
15 spacer
16 heater
17 temperature sensor
18 specimen
19 control device for probe microscope
20 control device for heater
21 detection device for temperature sensor
22 electronic computer
23 culture solution discharge port
24 optical fiber sensor
25 optical fiber for electromagnetic wave irradiation
26 hole

1. A measurement holder comprising:
a container in which a measurement object is housed;
a first cover section which covers at least a part of the measurement object and has an aperture for inserting a measurement probe; and
a second cover section which is connected to the first cover section, covers the container, and has an aperture for inserting the measurement probe.

2. The measurement holder according to claim 1, wherein a spacer for maintaining a predetermined height from the container is formed on the first cover section on the side of the container.

3. The measurement holder according to claim 1, wherein a hole for liquid injection and/or liquid discharge is formed in the second cover section.

4. The measurement holder according to claim 3, wherein an arrangement position of the hole is in a top part of the second cover section.

5. The measurement holder according to claim 3, wherein an arrangement position of the hole is in a lateral part of the container.

6. The measurement holder according to claim 1, wherein a heating element for heating the container is further provided.

7. The measurement holder according to claim 6, further comprising a temperature measurement sensor for measuring temperature of the container.

8. The measurement holder according to claim 7, wherein the heating element and/or the temperature measurement sensor is attachable to and removable from the container.

9. The measurement holder according to claim 6, wherein the heating element is provided on the container.

10. The measurement holder according to claim 6, wherein the heating element is an optical fiber.

11. The measurement holder according to claim 7, wherein the temperature measurement sensor is an optical fiber.

12. A probe microscope comprising:
an oscillator;
a probe provided at a distal end of the oscillator;
a unit for measuring a surface of a measurement object as the probe scans the surface of the measurement object; and
a measurement holder including a container in which the measurement object is housed, a first cover section which covers at least a part of the measurement object and has an aperture for inserting the probe, and a second cover section which is connected to the first cover section, covers the container, and has an aperture for inserting the probe.

13. A specimen measurement method using a measurement holder including a container in which a measurement object is housed, a first cover section which covers at least a part of the measurement object and has an aperture for inserting a measurement probe, and a second cover section which is connected to the first cover section, covers the container, and has an aperture for inserting the measurement probe, the method comprising:
a step of housing the measurement object along with a liquid in the container of the measurement holder; and
a step of, while adjusting a heating temperature of a heating element for heating the measurement object according to a temperature detected by a temperature measurement sensor for measuring a temperature of the measurement object, causing the measurement probe to scan a surface of the measurement object via the measurement holder, thereby measuring the surface of the measurement object.
